(19) United States
(12) Patent Application Publication
(10) Pub. No.: US 2008/0031152 A1
(43) Pub. Date: Feb. 7, 2008

(54) Method of measuring variance of data payload in wireless communications system and related apparatus

(75) Inventor: Li-Chih Tseng, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited, Tortola (VG)

(21) Appl. No.: 11/882,863

(22) Filed: Aug. 6, 2007

Related U.S. Application Data
(60) Provisional application No. 60/835,880, filed on Aug. 7, 2006.

(51) Int. Cl. G06F 11/00

(52) U.S. Cl. 370/252

(57) ABSTRACT

In order to prevent traffic volume measurement errors, especially variance measurement errors, the present invention provides a method of measuring variance of a data payload in a wireless communications system. The method includes the following steps. Plural variance reference values are predetermined. A variance measurement result related to data payload is reported. If the variance measurement result is greater than the plural variance reference values, the variance measurement result is rounded downwards to the maximum variance reference value of the plural variance reference values. Preferably, the plural variance reference values have a maximum value of 16 K and a minimum value of 0, where K is 1024. The plural variance reference values other than the minimum value form a geometric sequence.

### CROSS REFERENCE TO RELATED APPLICATIONS

This application claims the benefit of U.S. Provisional Application No. 60/835,880, filed on Aug. 7, 2006 and entitled “METHOD AND APPARATUS FOR TRAFFIC VOLUME MEASUREMENT AND SCHEDULING INFORMATION REPORTING”, the contents of which are incorporated herein by reference.

### BACKGROUND OF THE INVENTION

1. Field of the Invention

The present invention relates to methods and related communications devices for traffic volume measurement, and more particularly to methods of measuring variance of a data payload for a wireless communications system and related communications devices.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, providing these functions under limited resources relies on proper resource allocation. Thus, targeting third generation mobile telecommunication technology, the prior art provides a traffic volume measurement (TVM) mechanism, which is used to obtain instant transmission status and resource utilization to realize dynamic radio resource control.

According to a medium access control (MAC) specification 3GPP TS 25.321 V7.1.0, defined by the 3rd Generation Partnership Project (3GPP), in an acknowledged or unacknowledged mode (AM or UM), a radio resource control (RRC) layer performs a TVM process that requires the MAC layer to measure traffic volume information during at least a transmission time interval (TTI) and then report measurement results to the RRC layer. During the TVM process, the RRC layer configures the MAC layer to keep track of statistics on buffer occupancy (BO) of radio link control (RLC) entities. With the BO, the RRC layer can obtain transmission statuses in the RLC layer. According to Section 11.1, the RRC layer requests the MAC layer report with a primitive CMAC-Measure-REQ, including a reporting quantity identifier and a time interval. The reporting quantity identifier indicates what should be reported to the RRC layer, such as the BO, average of the BO, or variance of the BO. If either of the average of the BO and variance of the BO is required, the MAC layer calculates the average or variance of the BO during the time interval based on one sample of the BO per 10 microseconds. In addition, the MAC layer receives RLC packet data units (PDUS) with a primitive MAC-Data-REQ including the BO, which indicates for each logic channel the amount of data in number of bytes that is available for transmissions and retransmissions in the RLC layer.

The RRC specification 3GPP TS 25.331 V7.1.0 defines an information element (IE) named traffic volume measured result list. Three IEs, RLC Buffers Payload, Average of RLC Buffer Payload and Variance of RLC Buffer Payload are included in the traffic volume measured result list IE and provided with reference values, respectively. The Variance of RLC Buffer Payload IE has variance reference values of 0, 4, 8, . . . 1024, 2 K, 4 K, 8 K and 16 K Bytes, where K is 1024. When the variance of the BO is reported from the MAC layer, the RRC layer rounds the variance of the BO upwards to the closest variance reference value and further reports the closest variance reference value to an upper layer for dynamic radio resource control. Assuming that the variance of the BO is reported with a value of 15.8 K, the RRC layer rounds 15.8 K upwards to 16 K and then reports 16K to the upper layer. As known from the above, a rational measurement of the variance of the BO must not be over 16 K. However, if the MAC layer takes seven BO samples of 0.25 K, 0.5 K, 2 K, 4 K, 7 K, 9 K and 10 K during the given time interval, the variance of the samples is calculated to be 16.18 K. In this situation, since the reporting variance of the BO is greater than the maximum variance reference value, no variance reference values are available for the reporting variance of the BO to round upwards to, resulting in TVM errors.

### SUMMARY OF THE INVENTION

The present invention provides methods of measuring variance of a data payload for a wireless communications system and related communications devices that can prevent traffic volume measurement (TVM) errors or reduce probability of the TVM errors so as to improve radio resource allocation.

The present invention discloses a method of measuring variance of a data payload for a wireless communications system. The method includes predetermining plural variance reference values; receiving a variance measurement result; and rounding the variance measurement result downwards to a maximum variance reference value of the plural variance reference values if the variance measurement result is greater than the plural variance reference values. Preferably, the plural variance reference values have a maximum variance reference value of 16 K and a minimum variance reference value of 0, where K is 1024. The plural variance reference values other than the minimum variance reference value form a geometric sequence.

The present invention discloses a communications device utilized in a wireless communications system for measuring variance of a data payload to prevent traffic volume measurement errors. The communications device includes a control circuit, a central processing unit and a memory. The control circuit is used for realizing functions of the communications device. The central processing unit is installed in the control circuit and is used for executing a program code to operate the control circuit. The memory is installed in the control circuit and coupled to the central processing unit, used for storing the program code. The program code includes predetermining plural variance reference values; receiving a variance measurement result; and rounding the variance measurement result downwards to a maximum variance reference value of the plural variance reference values if the variance measurement result is greater than the plural variance reference values. Preferably, the plural variance reference values have a maximum variance reference value of 16 K and a minimum variance reference value of 0. The plural variance reference values other than the minimum variance reference value form a geometric sequence.

The present invention further discloses a method of measuring variance of a data payload for a wireless communications system. The method includes predetermining plural variance reference values; receiving a variance measurement result; and adding at least one backup value into the plural variance reference values if the variance measurement result is greater than the plural variance reference values, where the at least one backup value is greater than or equal to the variance measurement result. Preferably, the predetermined plural variance reference values have a maximum variance reference value of 16 K and a minimum variance reference value of 0. The predetermined plural variance reference values other than the minimum variance reference value form a geometric sequence.

The present invention further discloses a communications device utilized in a wireless communications system for measuring variance of a data payload to prevent traffic volume measurement errors. The communications device includes a control circuit, a central processing unit and a memory. The control circuit is used for realizing functions of the communications device. The central processing unit is installed in the control circuit and is used for executing a program code to operate the control circuit. The memory is installed in the control circuit and coupled to the central processing unit, used for storing the program code. The program code includes predetermining plural variance reference values; receiving a variance measurement result; and adding at least one backup value into the plural variance reference values if the variance measurement result is greater than the plural variance reference values, where the at least one backup value is greater than or equal to the variance measurement result. Preferably, the predetermined plural variance reference values have a maximum variance reference value of 16 K and a minimum variance reference value of 0. The predetermined plural variance reference values other than the minimum variance reference value form a geometric sequence.

The present invention further discloses a method of measuring variance of a data payload for a wireless communications system. The method includes predetermining plural variance reference values and increasing a maximum variance reference value of the plural variance reference values. Preferably, the predetermined plural variance reference values have a maximum variance reference value of 16 K and a minimum variance reference value of 0. The predetermined plural variance reference values other than the minimum variance reference value form a geometric sequence.

The present invention further discloses a communications device utilized in a wireless communications system for measuring variance of a data payload to reduce probability of traffic volume measurement errors. The communications device includes a control circuit, a central processing unit and a memory. The control circuit is used for realizing functions of the communications device. The central processing unit is installed in the control circuit and is used for executing a program code to operate the control circuit. The memory is installed in the control circuit and coupled to the central processing unit, used for storing the program code. The program code includes predetermining plural variance reference values and increasing a maximum variance reference value of the plural variance reference values. Preferably, the predetermined plural variance reference values have a maximum variance reference value of 16 K and a minimum variance reference value of 0. The predetermined plural variance reference values other than the minimum variance reference value form a geometric sequence.

The present invention further discloses a method of measuring variance of a data payload for a wireless communications system. The method includes predetermining plural variance reference values and multiplying the plural variance reference values by a same multiplier to increase differences between any two neighboring variance reference values of the plural variance reference values. Preferably, the predetermined plural variance reference values have a maximum variance reference value of 16 K and a minimum variance reference value of 0. The predetermined plural variance reference values other than the minimum variance reference value form a geometric sequence.

The present invention further discloses a communications device utilized in a wireless communications system for measuring variance of a data payload to reduce probability of traffic volume measurement errors. The communications device includes a control circuit, a central processing unit and a memory. The control circuit is used for realizing functions of the communications device. The central processing unit is installed in the control circuit and is used for executing a program code to operate the control circuit. The memory is installed in the control circuit and coupled to the central processing unit, used for storing the program code. The program code includes predetermining plural variance reference values and multiplying the plural variance reference values by a same multiplier to increase differences between any two neighboring variance reference values of the plural variance reference values. Preferably, the predetermined plural variance reference values have a maximum variance reference value of 16 K and a minimum variance reference value of 0. The predetermined plural variance reference values other than the minimum variance reference value form a geometric sequence.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIGS. 3-6 are flowcharts of a process according to an embodiment of the present invention.

### DETAILED DESCRIPTION

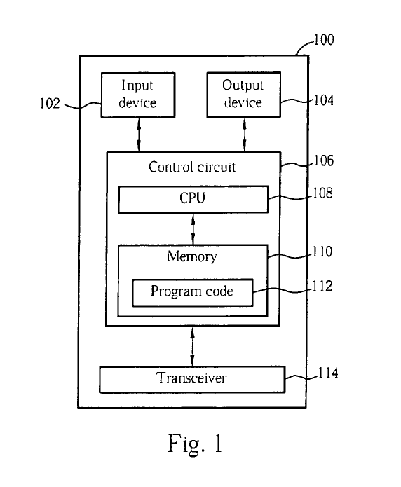

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is applied to the third generation telecommunications system.

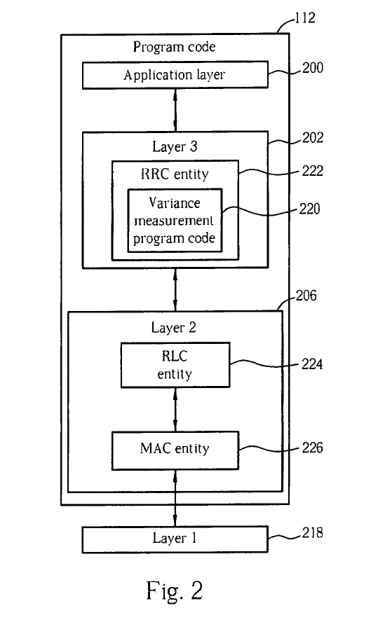

Please continue to refer to FIG. 2, which is a diagram of the program code 112 shown in FIG. 1. The program code 112 includes an application layer 200, a Layer 3 202, and a Layer 2 206, and is coupled to a Layer 1 218. The Layer 2 206 comprises two sub-layers: a radio link control (RLC) entity 224 and a media access control (MAC) entity 226. The MAC entity 226 exchanges signals and protocol data units (PDUs) with the RLC entity 224 through logic channels. The Layer 3 202 includes a radio resource control (RRC) entity 222 utilized to request the MAC entity 226 to perform traffic volume measurement (TVM) and report back with measurement results. During the TVM, the MAC entity obtains information about data payload of related buffers from RLC PDUs and thereby performs measurement calculation. A buffer occupancy (BO) parameter is utilized to notify states of the data payload of the RLC buffers, and the detailed description thereof has been described in the foregoing. The required measurement results may include BO, average of BO, or variance of BO. According to the measurement results reported from the MAC entity 226, the RRC entity 222 may perform radio resource allocation to the Layer 1 218 and the Layer 2 206. Furthermore, the MAC entity 226 can perform channel mapping, multiplexing, transport format selection, or random access control according to Layer 3 202 resource allocation signaling.

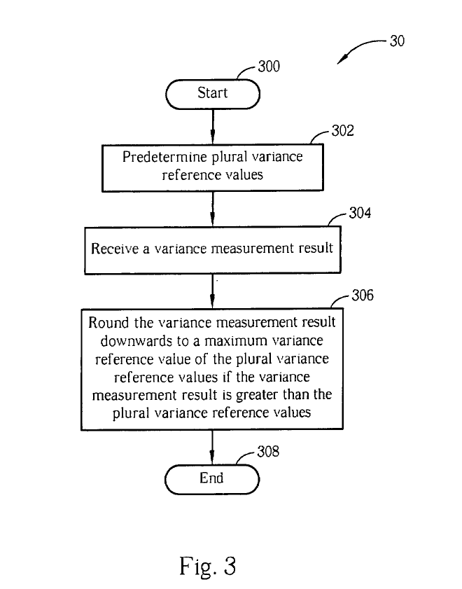

The embodiment of the present invention provides a variance measurement program code 220 to prevent TVM errors and further improve radio resource allocation. Please refer to FIG. 3, which is a flowchart of a process 30 according to an embodiment of the present invention. The process 30 can be compiled into the variance measurement program code 220 and includes the following steps:
Step 300: Start.
Step 302: Predetermine plural variance reference values.
Step 304: Receive a variance measurement result.
Step 306: Round the variance measurement result downwards to a maximum variance reference value of the plural variance reference values if the variance measurement result is greater than the plural variance reference values.
Step 308: End.

According to the process 30, the RRC layer predetermines the plural variance reference values before the TVM is performed. Preferably, the plural variance reference values have a maximum variance reference value of 16 K (K=1024) and a minimum variance reference value of 0. The plural variance reference values other than the minimum variance reference value form a geometric sequence. For example, the variance reference values are predetermined to be 0, 4, 8, . . . 1024, 2 K, 4 K, 8 K and 16 K. If the variance measurement result is less than the maximum variance reference value of 16 K, the variance measurement result is rounded upwards to the closest variance reference value. Assuming that the variance measurement result reported from the MAC layer is 7 K, the RRC layer rounds 7 K upwards to 8 K. Contrarily, if BO samples are taken to be 0.25 K, 0.5 K, 2 K, 4 K, 7 K, 9 K and 10 K Bytes in the MAC layer, the variance measurement result is 16.8 K. In this situation, 16.8 K will be rounded downwards to 16 K. Thus, the process 30 can prevent TVM errors.

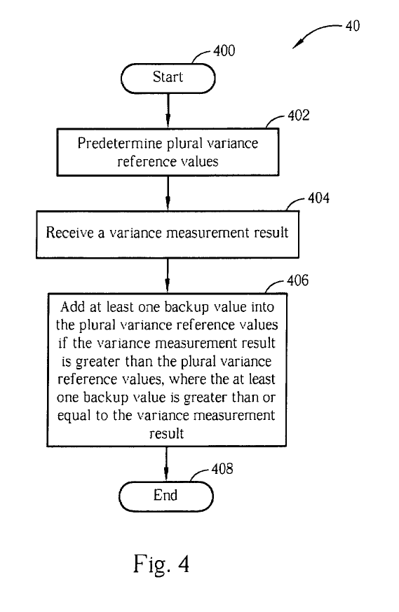

Please refer to FIG. 4, which is a flowchart of a process 40 according to an embodiment of the present invention. The process 40 can be compiled into the variance measurement program code 220 and includes the following steps:
Step 400: Start.
Step 402: Predetermine plural variance reference values.
Step 404: Receive a variance measurement result.
Step 406: Add at least one backup value into the plural variance reference values if the variance measurement result is greater than the plural variance reference values, where the at least one backup value is greater than or equal to the variance measurement result.
Step 408: End.

According to the process 40, the RRC layer predetermines the plural variance reference values before the TVM is performed. Preferably, the predetermined variance reference values have a maximum variance reference value of 16 K (K=1024) and a minimum variance reference value of 0. The predetermined variance reference values other than the minimum variance reference value form a geometric sequence. For example, the variance reference values are predetermined to be 0, 4, 8, . . . 1024, 2 K, 4 K, 8 K and 16 K. If the variance measurement result is less than the maximum variance reference value of 16 K, the variance measurement result is rounded upwards to the closest variance reference value. Assuming that the variance measurement result reported from the MAC layer is 7 K, the RRC layer rounds 7 K upwards to 8 K. Contrarily, if BO samples are taken to be 0.25 K, 0.5 K, 2 K, 4 K, 7 K, 9 K and 10 K Bytes in the MAC layer, the variance measurement result is 16.8 K. In this situation, at least one backup value is added into the variance reference values before the variance measurement result is rounded. For example, the added backup values can be 18 K and 20 K. Thus, the variance measurement result is rounded upwards to 18 K. Alternatively, the variance measurement result can be considered as the backup value to add into the variance reference values.

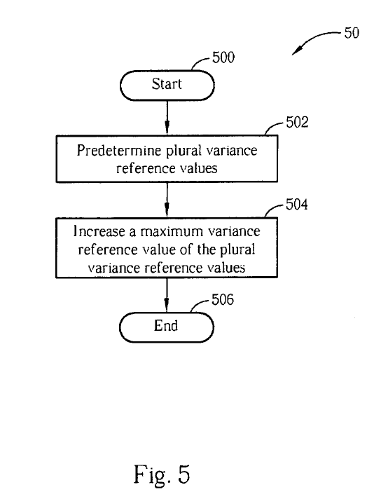

Please refer to FIG. 5, which is a flowchart of a process 50 according to an embodiment of the present invention. The process 50 can be compiled into the variance measurement program code 220 and includes the following steps:
Step 500: Start.
Step 502: Predetermine plural variance reference values.
Step 504: Increase a maximum variance reference value of the plural variance reference values.
Step 506: End.

According to the process 50, the RRC layer predetermines the plural variance reference values before the TVM is performed. Preferably, the predetermined variance reference values have a maximum variance reference value of 16 K (K=1024) and a minimum variance reference value of 0. The predetermined variance reference values other than the minimum variance reference value form a geometric sequence. For example, the variance reference values are predetermined to be 0, 4, 8, . . . 1024, 2 K, 4 K, 8 K and 16 K. The maximum variance reference value is then increased from 16 K to 18 K. When a variance measurement result is reported from the MAC layer, the RRC layer rounds upwards according to the variance reference values of 0, 4, 8, . . . 1024, 2 K, 4 K, 8 K and 18 K. If the variance measurement result is 7 K, 7 K will be rounded upwards to 8 K. If the variance measurement result is 16.8 K, 16.8 K will be rounded upwards to 18 K. The process 50 expands the acceptable range for the variance measurement result to reduce the probability that the reported variance measurement result is greater than the maximum variance reference value.

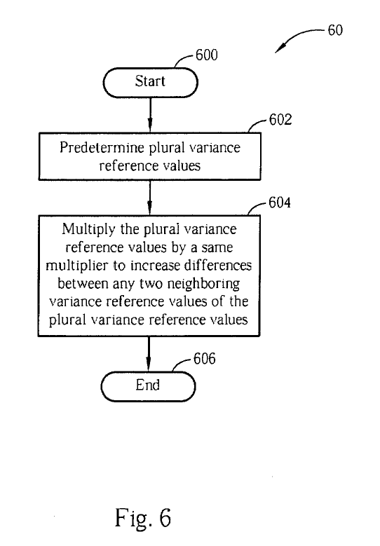

Please refer to FIG. 6, which is a flowchart of a process 60 according to an embodiment of the present invention. The process 60 can be compiled into the variance measurement program code 220 and includes the following steps:
Step 600: Start.
Step 602: Predetermine plural variance reference values.
Step 604: Multiply the plural variance reference values by a same multiplier to increase differences between any two neighboring variance reference values of the plural variance reference values.
Step 606: End.

According to the process 60, the RRC layer predetermines the plural variance reference values before the TVM is performed. Preferably, the predetermined variance reference values have a maximum variance reference value of 16 K (K=1024) and a minimum variance reference value of 0. The predetermined variance reference values other than the minimum variance reference value form a geometric sequence. For example, the variance reference values are predetermined to be 0, 4, 8, . . . 1024, 2 K, 4 K, 8 K and 16 K. The variance reference values are then multiplied by a same multiplier. For example, the multiplier is set to be 2, the variance reference values become 0, 8, 16, . . . 2 K, 4 K, 8 K, 16 K and 32 K. When a variance measurement result is reported from the MAC layer, the RRC layer will round the variance measurement result upwards to the closest variance reference value. For example, if the variance measurement result is 7 K, 7 K will be rounded upwards to 8 K. If the variance measurement result is 16.8 K, 16.8 K will be rounded upwards to 32 K. Thus, by expanding the differences between any two neighboring variance reference values, the process 60 can reduce the probability that the reported variance measurement result is greater than the maximum variance reference value.

To summarize, according to the prior art, the maximum variance reference value of 16 K may be too small to apply to certain communications environments. It is likely that the reported variance measurement result is greater than the maximum variance reference value, which results in the TVM errors. In the embodiments of the present invention, the processes 30 and 40 can prevent occurrence of the situation. The processes 50 and 60 can reduce probability of occurrence of the situation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of measuring variance of a data payload for a wireless communications system, the method comprising:
predetermining plural variance reference values;
receiving a variance measurement result; and
rounding the variance measurement result downwards to a maximum variance reference value of the plural variance reference values if the variance measurement result is greater than the plural variance reference values.

2. The method of claim 1 further comprising rounding the variance measurement result upwards to the closest variance reference value of the plural variance reference values if the variance measurement result is less than the maximum variance reference value of the plural variance reference values.

3. The method of claim 1, wherein the variance measurement result is obtained by measuring a variance of data stored in a buffer of a radio link control entity.

4. The method of claim 1, wherein the maximum variance reference value of the plural variance reference values is 16 K Bytes, and K is 1024.

5. The method of claim 1, wherein the plural variance reference values have a minimum variance reference value of 0, and the plural variance reference values other than the minimum variance reference value form a geometric sequence.

6. The method of claim 1, wherein the wireless communications system is a third generation wireless communications system.

7. A communications device utilized in a wireless communications system for measuring variance of a data payload to prevent traffic volume measurement errors, the communications device comprising:
a control circuit for realizing functions of the communications device;
a central processing unit installed in the control circuit for executing a program code to operate the control circuit; and
a memory installed in the control circuit and coupled to the central processing unit, for storing the program code;
wherein the program code comprises:
predetermining plural variance reference values;
receiving a variance measurement result; and
rounding the variance measurement result downwards to a maximum variance reference value of the plural variance reference values if the variance measurement result is greater than the plural variance reference values.

8. The communications device of claim 7, wherein the program code further comprises rounding the variance measurement result upwards to the closest variance reference value of the plural variance reference values if the variance measurement result is less than the maximum variance reference value of the plural variance reference values.

9. The communications device of claim 7, wherein the variance measurement result is obtained by measuring a variance of data stored in a buffer of a radio link control entity.

10. The communications device of claim 7, wherein the maximum variance reference value of the plural variance reference values is 16 K Bytes, and K is 1024.

11. The communications device of claim 7, wherein the plural variance reference values have a minimum variance reference value of 0, and the plural variance reference values other than the minimum variance reference value form a geometric sequence.

12. The communications device of claim 7, wherein the wireless communications system is a third generation wireless communications system.

13. A method of measuring variance of a data payload for a wireless communications system, the method comprising:
predetermining plural variance reference values;
receiving a variance measurement result; and
adding at least one backup value into the plural variance reference values if the variance measurement result is greater than the plural variance reference values, the at least one backup value being greater than or equal to the variance measurement result.

14. The method of claim 13 further comprising rounding the variance measurement result upwards to the closest variance reference value of the plural variance reference values after the at least one backup value is added into the plural variance reference values.

15. The method of claim 13, wherein the variance measurement result is obtained by measuring a variance of data stored in a buffer of a radio link control entity.

16. The method of claim 13, wherein the predetermined plural variance reference values have a maximum variance reference value of 16 K Bytes, and K is 1024.

17. The method of claim 13, wherein the predetermined plural variance reference values have a minimum variance reference value of 0, and the predetermined plural variance reference values other than the minimum variance reference value form a geometric sequence.

18. The method of claim 13, wherein the at least one backup value comprises the variance measurement result.

19. The method of claim 13, wherein the wireless communications system is a third generation wireless communications system.

20. A communications device utilized in a wireless communications system for measuring variance of a data payload to prevent traffic volume measurement errors, the communications device comprising:
a control circuit for realizing functions of the communications device;
a central processing unit installed in the control circuit for executing a program code to operate the control circuit; and
a memory installed in the control circuit and coupled to the central processing unit, for storing the program code;
wherein the program code comprises:
predetermining plural variance reference values;
receiving a variance measurement result; and
adding at least one backup value into the plural variance reference values if the variance measurement result is greater than the plural variance reference values, the at least one backup value being greater than or equal to the variance measurement result.

21. The communications device of claim 20, wherein the program code further comprises rounding the variance measurement result upwards to the closest variance reference value of the plural variance reference values after the at least one backup value is added into the plural variance reference values.

22. The communications device of claim 20, wherein the variance measurement result is obtained by measuring a variance of data stored in a buffer of a radio link control entity.

23. The communications device of claim 20, wherein the predetermined plural variance reference values have a maximum variance reference value of 16 K Bytes, and K is 1024.

24. The communications device of claim 20, wherein the predetermined plural variance reference values have a minimum variance reference value of 0, and the predetermined plural variance reference values other than the minimum variance reference value form a geometric sequence.

25. The communications device of claim 20, wherein the at least one backup value comprises the variance measurement result.

26. The communications device of claim 20, wherein the wireless communications system is a third generation wireless communications system.

27. A method of measuring variance of a data payload for a wireless communications system, the method comprising:
predetermining plural variance reference values; and
increasing a maximum variance reference value of the plural variance reference values.

28. The method of claim 27 further comprising:
receiving a variance measurement result corresponding to data stored in a buffer of a radio link control entity; and
rounding the variance measurement result upwards to the closest variance reference value of the plural variance reference values after the maximum variance reference value is increased.

29. The method of claim 27, wherein the maximum variance reference value of the plural variance reference values before being increased is 16 K Bytes, and K is 1024.

30. The method of claim 27, wherein the predetermined plural variance reference values have a minimum variance reference value of 0, and the predetermined plural variance reference values other than the minimum variance reference value form a geometric sequence.

31. The method of claim 27, wherein the wireless communications system is a third generation wireless communications system.

32. A communications device utilized in a wireless communications system for measuring variance of a data payload to reduce probability of traffic volume measurement errors, the communications device comprising:
a control circuit for realizing functions of the communications device;
a central processing unit installed in the control circuit for executing a program code to operate the control circuit; and
a memory installed in the control circuit and coupled to the central processing unit, for storing the program code;
wherein the program code comprises:
predetermining plural variance reference values; and
increasing a maximum variance reference value of the plural variance reference values.

33. The communications device of claim 32, wherein the program code further comprises:
receiving a variance measurement result corresponding to data stored in a buffer of a radio link control entity; and
rounding the variance measurement result upwards to the closest variance reference value of the plural variance reference values after the maximum variance reference value is increased.

34. The communications device of claim 32, wherein the maximum variance reference value of the plural variance reference values before being increased is 16 K Bytes, and K is 1024.

35. The communications device of claim 32, wherein the predetermined plural variance reference values have a minimum variance reference value of 0, and the predetermined plural variance reference values other than the minimum variance reference value form a geometric sequence.

36. The communications device of claim 32, wherein the wireless communications system is a third generation wireless communications system.

37. A method of measuring variance of a data payload for a wireless communications system, the method comprising:
predetermining plural variance reference values; and
multiplying the plural variance reference values by a same multiplier to increase differences between any two neighboring variance reference values of the plural variance reference values.

38. The method of claim 37 further comprising:
receiving a variance measurement result corresponding to data stored in a buffer of a radio link control entity; and
rounding the variance measurement result upwards to the closest variance reference value of the plural variance reference values after the plural variance reference values are multiplied by the same multiplier.

39. The method of claim 37, wherein the predetermined plural variance reference values have a maximum variance reference value of 16 K Bytes, and K is 1024.

40. The method of claim 37, wherein the predetermined plural variance reference values have a minimum variance reference value of 0, and the predetermined plural variance reference values other than the minimum variance reference value form a geometric sequence.

41. The method of claim 37, wherein the wireless communications system is a third generation wireless communications system.

42. A communications device utilized in a wireless communications system for measuring variance of a data payload to reduce probability of traffic volume measurement errors, the communications device comprising:
a control circuit for realizing functions of the communications device;
a central processing unit installed in the control circuit for executing a program code to operate the control circuit; and
a memory installed in the control circuit and coupled to the central processing unit, for storing the program code;
wherein the program code comprises:
predetermining plural variance reference values; and
multiplying the plural variance reference values by a same multiplier to increase differences between any two neighboring variance reference values of the plural variance reference values.

43. The communications device of claim 42, wherein the program code further comprises:
receiving a variance measurement result corresponding to data stored in a buffer of a radio link control entity; and
rounding the variance measurement result upwards to the closest variance reference value of the plural variance reference values after the plural variance reference values are multiplied by the same multiplier.

44. The communications device of claim 42, wherein the predetermined plural variance reference values have a maximum variance reference value of 16 K Bytes, and K is 1024.

45. The communications device of claim 42, wherein the predetermined plural variance reference values have a minimum variance reference value of 0, and the predetermined plural variance reference values other than the minimum variance reference value form a geometric sequence.

46. The communications device of claim 42, wherein the wireless communications system is a third generation wireless communications system.
